(19) United States
(12) Patent Application Publication
(10) Pub. No.: US 2022/0355991 A1
(43) Pub. Date: Nov. 10, 2022

(54) PACKAGING MATERIAL AND PREPARING METHOD THEREOF

(71) Applicant: The Procter & Gamble Company, Cincinnati, OH (US)

(72) Inventors: Enjun Cheng, Beijing (CN); Christian Kohlweyer, Bad Vilbel (DE)

(21) Appl. No.: 17/706,663

(22) Filed: Mar. 29, 2022

(30) Foreign Application Priority Data
Apr. 25, 2021 (CN) PCT/CN2021/089685

(51) Int. Cl. B65D 65/42; B32B 29/00; B41M 1/04

(52) U.S. Cl. CPC B65D 65/42; B32B 29/005; B41M 1/04; B32B 2255/12; B32B 2307/538; B32B 2255/28; B32B 2255/26; B32B 2553/00

(57) ABSTRACT

The present invention relates to a printed substrate comprising a first paper layer, the first paper layer comprising a first side and an opposing second side, the first side comprising a flexography print area and a non-print area, wherein the flexography print area has a color density no less than about 0.70 as measured according to Color Density Test disclosed herein, and wherein the non-print area has a roughness in the range of from about 3 μm to about 15 μm as measured according to Surface Roughness Test disclosed herein; a package for accommodating one or more articles comprising the printed substrate; and a method of making the printed substrate.

### FIELD OF THE INVENTION

This invention relates to a printed substrate comprising a paper layer suitable for packages accommodating one or more articles, and a package made of the printed substrate, and a method for producing the printed substrate. The printed substrate provides premiumness appearance and natural looking.

### BACKGROUND OF THE INVENTION

Non-fragile, compressible consumer products such as disposable absorbent articles (e.g., diapers and training pants, disposable adult incontinence pants and feminine hygiene pads) are often packaged and sold at retail (i.e., placed on display and for sale in a retail store) in in protective packaging, such as boxes, containers, bags, blister packs, cartons, and the like. In addition to being protective, packaging for consumer products is wanted attractive and eye-catching so that consumers might stop and consider purchasing the packaged products. Therefore, packages are desired to provide aesthetic impression of the packages and/or convey the consumers information about the product as well as its basic functions such as protection of articles the package accommodates from external environments.

The printing of substrates for packages, such as woven and nonwoven substrates and films, is well known. Applying images to substrates by utilizing pigment or dye based inks is well known in the art. These images are generally applied for the purpose of making the article more aesthetically pleasing to the consumer and communicating product information to consumers. Inks can be placed using various methods known in the art such as gravure printing, flexographic printing, and offset printing, letter press, lithography, plateless, post press, and screen printing. Gravure printing is the direct transfer of liquid ink to substrate from a metal image carrier. The image is lower than the surface of the image carrier base. Flexography printing is the direct transfer of liquid ink to substrate from a photopolymer image carrier. The image is raised above the surface of the image carrier base. Offset printing is the indirect transfer of paste ink to substrate from a rubber ‘blanket’ that is intermediate to substrate and the thin metal image carrier. Examples of plateless printing include electronic printing, ink jet printing, magnetography, ion deposition printing, direct charge deposition printing, and the Mead Cycolour Photocapsule process. Flexographic printing is popular in printing package film for consumer goods as it is economical, has changeover flexibility, and can achieve good print quality.

Printing on a nonwoven substrate is generally difficult and has issues of poor print quality, low image vibrancy, poor color-to-color registration, poor print pitch control, and poor ink adhesion, especially in cases that the nonwoven substrate has a porous or coarse surface.

Some paper materials having loose-fiber fabricated structure such as mulberry paper including Haniji of Korean traditional paper, Washi of Japanese traditional paper and Sanapi or Hanapi paper of Chinese traditional paper, and mulberry-paper-looking paper such as Yolon paper ( [symbol] , [symbol] , [symbol] ) possess fascinating texture and premium looking with visible fibers due to its loose-fiber fabricated structure. These make these papers a favourable choice for highlighting premiumness of products. However, a high surface roughness due to the unevenly distributed surface-exposed fibers may result in undesirable printing quality when printing is applied.

Thus, there remains a need for a printed substrate for package conveying aesthetic impression with desirable print quality.

There still remains a need for a process for producing a printed substrate conveying aesthetic impression with desirable print quality in a cost effective way when a precursor substrate has a high surface roughness.

### SUMMARY OF THE INVENTION

The present invention provides a printed substrate comprising a first paper layer, the first paper layer comprising a first side and an opposing second side, the first side comprising a flexography print area and a non-print area, wherein the flexography print area has a color density no less than about 0.70 as measured according to Color Density Test disclosed herein, and wherein the non-print area has a roughness in the range of from about 3 μm to about 15 μm as measured according to Surface Roughness Test disclosed herein.

The present invention provides a package for accommodating one or more articles comprising a printed substrate disclosed herein.

The present invention also provides a method of making a printed substrate comprising: providing a substrate comprising a first paper layer, the first paper layer comprising a first side and an opposing second side wherein the first side has a surface roughness in the range of from about 3 μm to about 15 μm; subjecting the substrate to flexographic printing process; applying a primer in a pre-determined area on the first side of the first paper layer; and applying an ink on at least part of the pre-determined area where the primer is disposed, so that the first side comprises a flexography print area and a non-print area, wherein the print area has a color density no less than about 0.70 as measured according to Color Density Test, and wherein the non-print area has a surface roughness in the range of from about 3 μm to about 15 μm.

These and other features, aspects, and advantages of the present invention will become evident to those skilled in the art from a reading of the present disclosure.

### BRIEF DESCRIPTION OF THE DRAWINGS

FIG. 1 is a top view image of an example of a mulberry-paper looking paper

FIG. 2A is a microscopic image of a comparative printed substrate.

FIG. 2B is a microscopic image of a printed substrate according to the present invention.

FIG. 3 shows a schematic of a flexographic printing system.

FIG. 4 shows in more detail a part of FIG. 3.

### DETAILED DESCRIPTION OF THE INVENTION

All ranges are inclusive and combinable. The number of significant digits conveys neither limitations on the indicated amounts nor on the accuracy of the measurements. All numerical amounts are understood to be modified by the word “about” unless otherwise specifically indicated.

The term “absorbent article” as used herein refers to devices which absorb and contain body exudates, and, more specifically, refers to devices which are placed against or in proximity to the body of the wearer to absorb and contain the various exudates discharged from the body.

Typical absorbent articles of the present invention include but are not limited to diapers, adult incontinence briefs, training pants, diaper holders and liners, absorbent inserts and the like, as well as feminine hygiene products, such as sanitary napkins and panty liners, and the like. Absorbent articles also include wipes, such as household cleaning wipes, baby wipes, and the like.

“Comprise”, “comprises”, and “comprising” as used herein are open ended terms, each specifying the presence of what follows, e.g., a component, but not precluding the presence of other features, e.g., elements, steps or components known in the art, or disclosed herein.

“Consist(s) of” and “consisting of” as used herein are close ended terms, each specifying the presence of what follows, e.g., a component, and precluding the presence of other features, e.g., elements, steps or components known in the art, or disclosed herein. “Consist(s) of”, and “essentially consist(s) of”, “consisting of”, and “essentially consisting of”, when used directly relative to a laminate having a film layer and a paper layer, means that the laminae does not include the first paper layer and only include the film layer.

“Film” means a sheet structure having a length, width and thickness (caliper), wherein each of the length and width greatly exceed the thickness, i.e., by a factor of 1,000 or more, the structure having one layer (monolayer) or more respectively adjacent layers (multilayer), each layer being a substantially continuous structure formed of one or more thermoplastic polymer resins (including blends thereof).

“Flexography” is a form of printing that uses flexible rubber relief plates.

### Printed Substrate

The printed substrate of the present invention comprises a first paper layer comprising a first side and an opposing second side, the first side comprising a flexography printed area and a non-print area. The print area may comprise about 1%-99% of the surface area of the first side of the first paper layer.

The printed substrate comprises a flexography print area with high printing quality such as a high color density, a high dot gain, and a high delta E, and a non-print area maintaining original properties such as a surface roughness and surface appearance of the paper forming the first paper layer. With a flexography print area with high printing quality and a non-print area maintaining original paper property and appearance, the printed substrate of the present invention can deliver improved aesthetic appearance and premiumness looking as well as natural feeling.

In one embodiment, the printed substrate of the present invention is a laminate comprising a first paper layer comprising a first side and an opposing second side, the first side comprising a flexography printed area and a non-print area, and a film layer disposed on the second side of the first paper layer. The film layer in the laminate may be a single layer (monolayer), or may have two, three or more layers (multilayer). A multilayer film may have, for example, a first skin layer formed of a first polymer and a second skin layer formed of a second polymer.

A laminate comprising a first paper and a film layer may be produced by combining the film layer and the first paper layer together using adhesive. Suitable adhesive includes, but are not limited to, solvent-based adhesive, acrylic water-based adhesive, and solvent-less adhesive. The combined film and paper layers may be thermally and/or chemically cured. At least one of the film and paper layer may be printed before combined together. The laminate may be produced according to a conventional extrusion bonded laminate production process by extruding a molten film directly on to a first paper layer.

In another embodiment, the substrate of the present invention is a laminate comprising a first paper layer comprising a first side and an opposing second side, the first side comprising a flexography printed area and a non-print area, and a second paper layer disposed on the second side of the first paper layer. A laminate comprising a first paper layer and a second payer layer may be produced by combining the first paper and the second paper layer together using adhesive.

### Paper Layer

The first paper layer comprising a first side and an opposing second side, the first side comprising a flexography printed area and a non-print area.

“Paper”, used herein related to a paper layer, intends to include synthetic paper as well as natural paper. Natural paper may manufactured from a composition comprising natural fibers such as cotton, silk, wool, hemp, pulp, and the like; or reclaimed fibers such as rayon, cupra. For example, the first paper layer comprises cellulose-based fibers. The term “cellulose-based fibers”, as used herein, intends to include both cellulose fibers such as pulp and cotton, and regenerated cellulose fiber such as rayon unless specified differently. Synthetic paper may be manufactured from a composition comprising plastic fibers such as polyethylene and polypropylene and the like.

A first paper layer suitable for the present invention comprises a first side with a surface roughness in the range from about 3 μm to about 15 μm, or in the range from about 4 μm to about 15 μm, or the range from about 5 μm to about 10 μm, as measured according to Roughness Test disclosed herein. When the surface roughness is lower than 3 μm or higher than 15 μm, the first paper layer may not provide desirable premium-ness appearance and a natural looking.

A basis weight of the first paper layer may be in the range of from about 10 gsm to about 200 gsm. Paper type and an appropriate basis weight may be selected depending on package application areas, processibility in lamination, wicket bag folding, and/or package folding process. Papers suitable for the first paper layer comprises fibers non-homogenously distributed at least on a first side of the first paper layer which provides irregular fiber pattern on a surface of the paper. Examples of such paper include mulberry paper such as Washi and Hanji, and synthetic paper made by synthetic fibers having appearance similar to mulberry paper such as COLOR SILK PAPER from Mi Sung Paper CO. (Korea), and Yolon paper ( [symbol] , [symbol] , [symbol] [symbol] ).

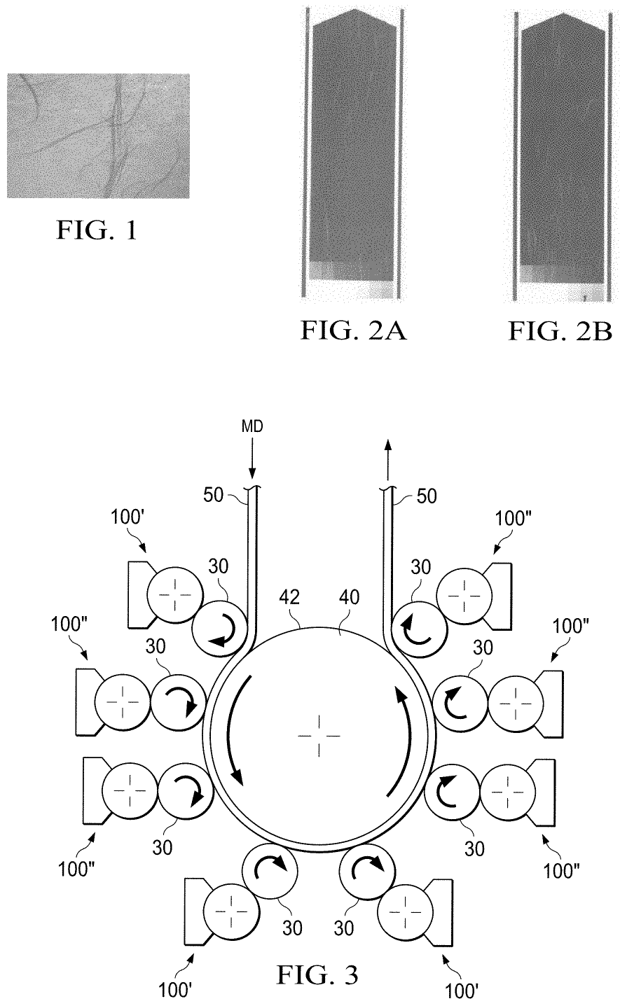

Referring to FIG. 1, mulberry-paper-looking paper possesses an aesthetic appearance as well as natural feeling due to its loose-fiber fabricated structure providing irregular fiber pattern on a paper surface.

The printed substrate of the present invention may comprise a second paper layer disposed on the second side of the first paper layer. The second paper layer may comprise synthetic fibers, natural fibers, or a combination thereof.

### Print Area

The print area on the first side of the first paper layer is an area printed by flexography print having improved printing quality despite original paper layer has a relatively high surface roughness.

The print area has a color density no less than about 0.70, or no less than 0.72, or no less than 9.74 as measured according to Color Density Test disclosed herein. The print area may have a Dot gain no less than about 65%, or no less than 67%, or no less than about 70% as measured according to Dot Gain Test disclosed herein. The print area may have a delta E no less than 4.5 as measured according to Delta E Test disclosed herein.

The print area may comprise a primer and an ink disposed over at least part of the primer.

The primer may comprise a binder polymer, a solvent and a white pigment. The binder polymer for the primer may be selected from the group consisting of nitrocellulose polyurethane, nitrocellulose polyamide and combinations thereof. The solvent for the primer is one suitable for flexography print such as ethanol, isopropyl alcohol and ethyl acetate.

The primer may comprise at least about 1% a white pigment. Titanium dioxide, zinc oxide, lithopone and/or zinc sulfide are examples of white pigment. Titanium dioxide is preferred as white pigment. Titanium dioxide exists in three different crystalline forms, rutile, anatase and brookite. The rutile and anatase forms have the highest refractive index of all white pigments, and provide the highest coverage for ink coatings. Rutile has the greatest opacity, and anatase has the greatest whiteness. The anatase form is most preferred. Pigments are typically subject to modification by grinding and/or surface treatment, for example. Grinding may modify surface area, with higher surface areas generally preferred.

The present inventors have found that printing quality of a printed area on the paper layer can be maximized by using a specific primer in the printed area. It has been found that a specific mixture of white pigment with polymer results in a high color density, a high dot gain, and/or a high delta E even for a paper material with a high surface roughness. Examples for the primer suitable therefore include K-primer (PG12SC67) and F-primer (PG12SC66) available from Sun Chemical Europe, and PB-1 primer (XS-716 709 White Ink No. 3 plus Medium (20.5% TiO2)), and PC-1 primer (XS-716 709 White Ink No. 3 (41% TiO2)) available from DIC Corporation (Tokyo, Japan).

In order to improve printing quality, the following combination of the above factors may be considered. In a typical embodiment, the primer suitable for the present invention comprises at least about 1% a white pigment, a polymer selected from the group consisting of nitrocellulose polyurethane, nitrocellulose polyamide and combinations thereof. In certain embodiments, the anilox cup volume of the primer is ranging from 5 to 40g/m², or from 10 to 30 g/m², or from 15 to 30 g/m², or from 15 to 25g/m².

The ink which may be used with the present invention is any liquid composition which may be applied onto the substrate in a predetermined pattern. Components of the ink may include but are not limited to: a vehicle such as a solvent or water; a colorant such as a pigment or dye; a binder; and other components which may include but are not limited to wax, crosslinking agents, fixatives, pH control agents, viscosity modifiers, defoamers, dispersants, printing press hygiene control agents, preservatives, and corrosion control agents.

As used herein, “ink” refers to any composition or components thereof applied to the substrate and which remains thereon in a visible pattern even though components of the ink may evaporate. The components of the ink may be applied to the substrate sequentially or as a mixture. As used herein, “vehicle” refers to the liquid component of the ink utilized to convey the ink to the surface of the substrate. As used herein, “pigment” refers to insoluble color matter used in finely divided dispersed form to impart color to the ink. As used herein, “dye” refers to a colorant soluble in the continuous phase of the ink. As used herein, “binder” refers to the adhesive component of the ink.

Suitable inks include but are not limited to those inks that are in the form of a liquid at room temperature (i.e.; a temperature of about 20° C.). The inks will preferably utilize water as a vehicle and pigment as a colorant suitable for flexographic printing.

A binder is generally needed for the ink to adhere to the surface of the substrate. In general, rub-off resistance of the ink increases as adherence of the ink to the surface of the substrate increases. Inks which include binders comprised of film-forming polymers tend to have improved adherence of the ink to the surface of the substrate in comparison to inks containing non film-forming binders.

The print area in the substrate of the present invention is a flexography print area.

The printed substrate of the present invention may be produced by a process which comprises: providing a substrate comprising a first paper layer, the first paper layer comprising a first side and an opposing second side wherein the first side has a surface roughness in the range of from about 2 μm to about 15 μm; subjecting the substrate to flexographic printing process; applying a primer in a pre-determined area on the first side of the first paper layer; and applying an ink on at least part of the pre-determined area where the primer is disposed, so that the first side comprises a flexography print area and a non-print area. A “predetermined area” refers to any desired area or array on the substrate and is inclusive of all combinations of patterns ranging from small individual dots to about 99% coverage of the entire surface of the substrate. The ink may be disposed on the entire area or part of the area where the primer is disposed. The print area has a color density no less than about 0.70 as measured according to Color Density Test, and wherein the non-print area has a surface roughness in the range of from about 2 μm to about 15 μm as measured according to Roughness Test disclosed herein.

The print area is formed using flexographic printing process well known in the printing industry.

Referring to FIG. 3, the printed substrate of the present invention may be produced by a method comprising the steps of: feeding a substrate 50 to be printed onto a rotating central impression cylinder 40; moving the substrate 50 past a first primer printing station 100′ arranged adjacent an outer surface 42 of the central impression cylinder, wherein the first primer printing station 100′ includes a print cylinder 30; rotating the print cylinder 30 of the first primer printing station 100′ to apply a primer on a predetermined area of a first side of the substrate 50; moving the substrate 50 past a plurality of ink printing stations 100″ arranged around an outer surface 42 of the central impression cylinder 40, wherein each ink printing station includes a print cylinder 30; rotating the print cylinders 30 of the ink printing stations 100″ to apply a series of ink over at least part of the predetermined area where the primer applied. The primer printing station 100′ may be a single printing station, or it may be a multiple printing stations. The primer may be printed on the substrate using one printing station, or multiple printing stations before the substrate move to the first ink printing station. The substrate 50 may be a first paper layer or a laminate comprising the first paper layer.

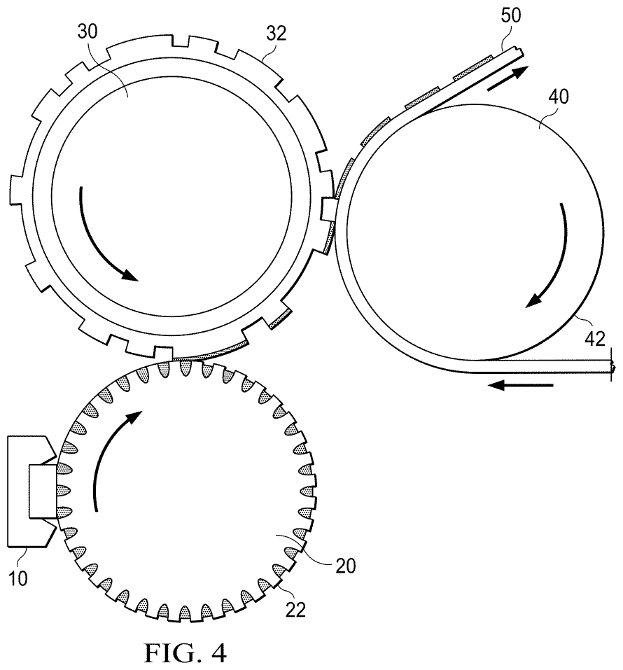

More specifically, referring to FIG. 4 showing in more detail a printing station 100′, 100″, the primer supply or an ink supplier 10 may be a chambered doctor blade system, preferably comprising a hard doctor blade and set to a doctor blade chamber pressure of from 1 to 4 bar. The anilox roller 20 serves to meter the volume of ink which is applied. Preferably, the outer surface 22 of the anilox roller comprises an array of cavities or “cells” 24 arranged from 100-250 lines per centimeter. The cells may be hexagonal in shape. Alternatively anilox rollers may also be used which do not comprise discrete cells such as High Volume Solids, Tri-Helical, Fluid, Open Channel and Open Slalom Ink Channel anilox engraved geometries. Printing plate 32 is disposed around the plate cylinder 30. Preferably the printing plate is a high definition printing plate comprising either an array of dots which are flat top dots or an array of dots which are round top dots with microcell structures. Impression surface 42 is disposed around the impression cylinder 40. A substrate 50 to be printed is passed between the printing plate 32 and the impression surface 42. Pressure is applied between the printing plate and the impression surface. The applied pressure may be from 80-220 N/m². Or, the speed at which the substrate is passed between the printing roll and the impression roll is from 10-600, or from 60-300 meters/minute.

### Non-Printed Area

The non-printed area in the printed substrate of the present invention maintains original properties of a paper material forming the first paper layer. For example, the non-printed area has a surface roughness in the range from about 2 μm to about 15 μm, or in the range from about 2 μm to about 12 μm, or the range from about 3 μm to about 10 μm, as measured according to Roughness Test disclosed herein.

### Test Method

### Roughness Test

Surface roughness of a sample substrate is measured according to ISO 4287:1997. Three replica for each test substrate are tested and mean value of the three replica is reported as a color density.

### Color Density Test

Color density refers to the property of a print area in a printed substrate which measures the amounts of colorants in a printed image. Color density is measured according to ISO-5:2009, Photography and graphic technology-Density measurements using blue color with pantone color No. PMS 293C. Three replica for each test substrate are tested and mean value of the three replica is reported as a color density.

### Dot Gain Test

Dot gain refers to the property of a print area in a printed substrate which measures printed dot distortion percentage during the printing process. Dot gain of a print area in a printed substrate is measured according to ISO-12647:2013, Graphic technology—Process control for the production of half-tone colour separations, proof and production prints. Three replica for each test substrate are tested and mean value of the three replica is reported as a dot gain.

### Color Delta E Test

Color delta E of a print area in a printed substrate is measured according to ASTM D2244. Three replica for each test substrate are tested and mean value of the three replica as a color delta

### EXAMPLES

### Example 1

Three papers, Papers 1-3 (SP106, SP107, SP108 from Mi Sung Paper CO. (Korea), respectively) were tested for surface roughness aaccording to Roughness Test disclosed herein. The same papers were assessed in a qualitative way for natural premiumness looking with 15 panelists by asking to describe the sample substrate. Results are indicated in Table 1 below.

TABLE 1

| | Paper 1 | Paper 2 | Paper 3 |
|---|---|---|---|
| Roughness (μm) | 55 | 6.7 | 2.9 |
| Consumer | Perceived as | Perceived | Perceived as |
| acceptance | off quality paper, | as natural | ordinary paper, |
| | worn paper, or | and premium | no premium |
| | easy to tear down | paper | looking |

### Example 2

Printed substrate samples were was produced as below.

Sample 1 (printed substrate 1): Sample 1 was produced using materials below. Paper layer: SP 107 available from Mi Sung Paper CO. (Korea) having surface roughness about 6.7 μm measured according to Roughness Test disclosed herein.

Primer: K-primer (PG12SC67) and F-primer (PG12SC66), available from Sun Chemical Europe

Ink: blue color with pantone color No. PMS 293C.

Using flexographic printing process, primers were deposited onto predetermined area on the paper layer using two printing stations. Flexo plates are attached to the print cylinder. The anilox cup volume was at 25 g/m² and the web speed is set at 220 m/min Then, the ink is applied at cup volumes of 7.5 g/m² onto the pre-determined area where the primer had been disposed.

Sample 2 (printed substrate 2): Sample 2 was produced using the same materials except using primers, PB-1 primer, XS-716 709 White Ink No. 3 plus Medium (20.5% TiO₂) and PC-1 primer (XS-716 709 White Ink No. 3 (41% TiO₂)) available from DIC Corporation (Tokyo, Japan) according to the same process for producing sample 1 above.

Sample 3 (comparative printed substrate): Sample 3 was produced using the same paper layer and an ink as used to produce sample 1 without deposition of a coating material on the paper layer, according to the same process for producing sample 1 above. That is, using flexographic printing process, the ink was applied to a predetermined area in the paper layer without primer deposition.

Color density, dot gain and delta F in printed area in the Samples 1-3 were measured according to Color Density Test, Dot gain Test and Delta E Test disclosed herein, and results are indicated in Table 2 Below.

TABLE 2

| | | Sample 1 | Sample 2 | Sample 3 |
|---|---|---|---|---|
| Non-printed area | Roughness (μm) | 6.7 | 6.7 | 6.7 |
| Printed area | Color density | 0.74 | 0.73 | 0.64 |
| | Dot gain (%) | 74.1 | 65.4 | 64 |
| | Delta E | 4.63 | 5.03 | NA |

Samples 1 and 2 exhibits improved printing quality represented by color density, dot again and delta E in comparison with Sample 3 which was printed without primer treatment before applying an ink.

### Example 3

Printed substrate samples were produced as below, and microscopic images of the substrate samples were taken. Sample 5 in FIG. 2B provides better printing quality appearance than Sample 4 in FIG. 2A.

TABLE 3

| | Sample 4 | Sample 5 |
|---|---|---|
| Substrate | SP 107 (Mi Sung Paper | SP 107 (Mi Sung Paper |
| | CO., Korea) | CO., Korea) |
| Primer | No primer | PB-1 |
| Primer coating | 0 | 11.25 |
| amount (g/m²) | | |
| Ink | XS-716 507 Blue | XS-716 507 Blue |
| Ink amount (BCM) | 3.2 | 3.2 |
| FIG | FIG. 2A | FIG. 2B |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A printed substrate comprising a first paper layer, the first paper layer comprising a first side and an opposing second side, the first side comprising a print area and a non-print area, wherein the print area is printed by flexography print, and has a color density no less than about 0.70 as measured according to Color Density Test, and wherein the non-print area has a surface roughness in the range of from about 3 μm to about 15 μm as measured according to Roughness Test.

2. The printed substrate according to claim 1, wherein the print area has a Dot gain no less than about 65% as measured according to Dot Gain Test.

3. The printed substrate according to claim 1, wherein the print area has a delta E no less than about 4.5 as measured according to Delta E Test.

4. The printed substrate according to claim 1, wherein the print area comprises a primer and an ink disposed over at least part of the primer,
wherein the primer comprises at least about 1% a white pigment.

5. The printed substrate according to claim 4, wherein the primer further comprises a polymer selected from the group consisting of nitrocellulose polyurethane, nitrocellulose polyamide and combinations thereof.

6. The printed substrate according to claim 1, wherein the print area comprises about 1%-99% of the first side of the first paper layer.

7. The printed substrate according to claim 1, the printed substrate further comprises a film layer disposed on the second side of the first paper layer.

8. The printed substrate according to claim 1, the printed substrate further comprises a second paper layer disposed on the second side of the first paper layer.

9. A package for disposable absorbent articles being made of a printed substrate according to claim 1.

10. A method of making a printed substrate, comprising:
a. providing a substrate comprising a first paper layer, the first paper layer comprising a first side and an opposing second side wherein the first side has a surface roughness in the range of from about 3 μm to about 10 μm,
b. subjecting the substrate to flexographic printing process;
c. applying a primer in a pre-determined area on the first side of the first paper layer, and
d. applying an ink on at least part of the pre-determined area where the primer is disposed, so that the first side comprises a flexography print area and a non-print area,
wherein the flexography print area has a color density no less than about 0.70 as measured according to Color Density Test, and wherein the non-print area has a surface roughness in the range of from about 3 μm to about 15 μm as measured according to Roughness Test disclosed herein.

11. The method of making a printed substrate according to claim 10, wherein the flexography print area has a Dot gain no less than about 65% as measured according to Dot Gain Test.

12. The method of making a printed substrate according to claim 10, wherein the print area has a delta E no less than about 4.5 as measured according to Delta E Test.

13. The method of making a printed substrate according to claim 10, wherein the flexography print area comprises a primer and an ink disposed over at least part of the primer,
wherein the primer comprises at least about 1% a white pigment.

14. The method of making a printed substrate according to claim 13, wherein the primer further comprises a polymer selected from the group consisting of nitrocellulose polyurethane, nitrocellulose polyamide and combinations thereof.

15. The method of making a printed substrate according to claim 10, wherein the flexography print area comprises about 1%-99% of the first side of the first paper layer.

16. The method of making a printed substrate according to claim 10, the substrate further comprises a film layer disposed on the second side of the first paper layer.

17. The method of making a printed substrate according to claim 10, the substrate further comprises a second paper layer disposed on the second side of the first paper layer.
